(19) United States
(12) Patent Application Publication
(10) Pub. No.: US 2026/0334422 A1
(43) Pub. Date: Oct. 29, 2026

(54) PET TOILET

(71) Applicant: PetPivot INC, PORTLAND, OR (US)

(72) Inventor: XIAOXIANG TANG, Shenzhen (CN)

(21) Appl. No.: 19/634,044

(22) Filed: Mar. 30, 2026

Related U.S. Application Data
(63) Continuation-in-part of application No. 18/541,428, filed on Dec. 15, 2023, now Pat. No. 12,616,163.

(30) Foreign Application Priority Data
Nov. 24, 2023 (CN) 202323196077.4

(51) Int. Cl. A01K 1/01

(52) U.S. Cl. CPC A01K 1/0114

(57) ABSTRACT

The present disclosure provides a pet toilet. When the roller rotates from the original position towards the defecation position, the pet litter can enter the third accommodation space through the sieve component, and the excrement is confined outside the third accommodation space. The sealing door opens the second opening, and the first opening rotates along with the roller to be aligned with the second opening, so that the excrement can be discharged by its own gravity into the second accommodation space through the first opening and the second opening. When the excrement is discharged into the second accommodation space of the fecal collection box, and the roller rotates from the defecation position towards the original position, the pet litter in the third accommodation can pass through the sieve component and falling back into the first accommodation space by its own gravity, and the sealing door closes the second opening.

### CROSS-REFERENCE TO RELATED APPLICATIONS

This application is a continuation in part of U.S. application serial No. 18/541,428, filed on Dec. 15, 2023, the content of which is incorporated by reference herein.

### TECHNICAL FIELD

The present disclosure relates to the field of pet toilets, in particular to a pet toilet.

### BACKGROUND

Current pet toilets mostly employ common containers, such as litter boxes. The litter boxes are filled with cat litter for pets to defecate. However, after defecation, pet owners are required to clean the excrement, which is time-consuming and labor-intensive. Moreover, the excrement in the litter boxes produces odors that are often unacceptable to the owners. Therefore, there is an urgent need on the market for an intelligent litter box capable of automatically cleaning feces, so as to improve user experience.

### SUMMARY

In order to overcome the shortcomings in the prior art, the present disclosure provides a pet toilet.

The pet toilet includes a roller. The roller is provided with a first opening and a first accommodation space. The first opening is in communication with the first accommodation space. The first accommodation space is configured for accommodating excrement of pets and pet litter.

The pet toilet further includes a base, and the base is configured for supporting the roller.

The pet toilet further includes a fecal collection box, and the fecal collection box is arranged under the base. The fecal collection box is provided with a second accommodation space and a second opening. The second opening is in communication with the second accommodation space.

The pet toilet further includes a sealing door, and the sealing door is arranged at the second opening.

The pet toilet further includes a sieve component, and the sieve component is connected to the roller. The sieve component and an inner wall of the roller are configured to surround to form a third accommodation space. The third accommodation space is adjacent to the first accommodation space. The sieve component is configured for sifting the pet litter from the excrement.

The pet toilet further includes a drive device, and the drive device is configured for driving the roller to rotate on the base. When the first opening rotates along with the roller from an original position towards a defecation position, the pet litter is capable of entering the third accommodation space through the sieve component, and the excrement is confined outside the third accommodation space. In addition, the sealing door is configured to open the second opening. The first opening is configured to rotate along with the roller to be aligned with the second opening, so that the excrement is capable of being discharged into the second accommodation space by its own gravity through the first opening and the second opening. When the first opening rotates along with the roller from the defecation position towards the original position, the pet litter in the third accommodation space is capable of passing through the sieve component and falling back into the first accommodation space by its own gravity. In addition, the sealing door is configured to close the second opening.

As an improvement of the present disclosure, when the first opening rotates along with the roller from an original position towards a defecation position, the pet litter is capable of entering the third accommodation space through the sieve component, and the excrement is confined outside the third accommodation space. In addition, the drive device is configured to drive the sealing door to open the second opening. The first opening is configured to rotate along with the roller to be aligned with the second opening, so that the excrement is capable of being discharged into the second accommodation space by its own gravity through the first opening and the second opening. When the first opening rotates along with the roller from the defecation position towards the original position, the pet litter in the third accommodation space is capable of passing through the sieve component and falling back into the first accommodation space by its own gravity. In addition, the drive device is configured to drive the sealing door to close the second opening.

As an improvement of the present disclosure, the drive device includes a drive assembly and a transmission assembly. The drive device is configured to drive the roller to rotate on the base. When the first opening rotates along with the roller from the original position towards the defecation position, the roller is configured to drive the sealing door to open the second opening through the transmission assembly. In addition, the first opening is configured to rotate along with the roller to be aligned with the second opening. In this way, the excrement is capable of being discharged by its own gravity into the second accommodation space through the first opening and the second opening. When the first opening rotates along with the roller from the defecation position towards the original position, the pet litter in the third accommodation space is capable of passing through the sieve component and falling back into the first accommodation space by its own gravity. In addition, the roller is configured to drive the sealing door to close the second opening through the transmission assembly.

As an improvement of the present disclosure, the transmission assembly includes a first transmission element and a second transmission element. The first transmission element is arranged on an outer side wall of the roller, and the second transmission element is arranged on the sealing door. When the first opening rotates along with the roller from the original position towards the defecation position, the first transmission element is connected in transmission with the second transmission element. The roller is configured for rotating to drive the first transmission element to rotate, and the first transmission element is configured for rotating to drive the second transmission element to move, so that the sealing door moves along with the second transmission element to open the second opening. The first opening is configured to rotate along with the roller to be aligned with the second opening, so that the excrement is capable of being discharged by its own gravity into the second accommodation space through the first opening and the second opening. When the first opening rotates along with the roller from the defecation position towards the original position, the first transmission element is connected in transmission with the second transmission element. In addition, the pet litter in the third accommodation space is capable of passing through the sieve component and falling back into the first accommodation space by its own gravity. The first transmission element is configured for rotating to drive the second transmission element to move, so that the sealing door moves along with the second transmission element to close the second opening.

As an improvement of the present disclosure, a sliding rail is arranged on the fecal collection box. The roller is configured for rotating to drive the first transmission element to rotate, and rotation of the first transmission element drives the second transmission element to move, so that the sealing door is configured to slide along with the second transmission element on the sliding rail until opening or closing the second opening.

As an improvement of the present disclosure, the first transmission element is a first arc-shaped rack arranged along an outer circumferential wall of the roller. The sealing door is a flat-shaped sealing door. The second transmission element is a second flat-shaped rack arranged on the sealing door. The sliding rail is a flat-shaped sliding rail. The roller is configured for rotating to drive the first rack to rotate, so that the first rack drives the second rack to move. Therefore, the sealing door is configured to slide along with the second rack on the sliding rail until opening or closing the second opening.

As an improvement of the present disclosure, the first transmission element is a first arc-shaped rack arranged along the outer circumferential wall of the roller. The sealing door is an arc-shaped sealing door. The second transmission element is a second arc-shaped rack arranged on the sealing door. The sliding rail is an arc-shaped sliding rail. The roller is configured for rotating to drive the first rack to rotate, so that the first rack drives the second rack to move. Therefore, the sealing door is configured to slide along with the second rack on the sliding rail until opening or closing the second opening.

As an improvement of the present disclosure, a third opening is defined in the base, and the third opening is positioned between the roller and the second opening. When the first opening rotates along with the roller from the original position towards the defecation position, the pet litter is capable of entering the third accommodation space through the sieve component, and the excrement is confined outside the third accommodation space. In addition, the sealing door is configured to open the second opening, and the first opening is configured to rotate along with the roller to be aligned with the third opening and the second opening. In this way, the excrement is capable of being discharged by its own gravity into the second accommodation space through the first opening and the second opening. When the first opening rotates along with the roller from the defecation position towards the original position, the first opening is misaligned with the second opening and the third opening. The pet litter in the third accommodation space is capable of passing through the sieve component and falling back into the first accommodation space by its own gravity, and the sealing door is configured to close the second opening.

As an improvement of the present disclosure, the drive assembly includes a drive motor, a driving gear, and a driven gear. The drive motor is provided with a drive shaft. The driving gear is sleeved on the drive shaft, and the driven gear is arranged on the roller. The driven gear meshes with the driving gear, so that the drive shaft rotates to drive the driving gear to rotate, the driving gear rotates to drive the driven gear to rotate, and the driven gear rotates to drive the roller to rotate on the base.

As an improvement of the present disclosure, a first supporting arm is arranged on a first side of the base, and a second supporting arm is arranged on a second side of the base. The first supporting arm and the second supporting arm are both provided with a supporting groove. Both sides of the roller are provided with supporting shafts, and the supporting shafts are positioned in the supporting grooves. A plurality of first wheels are arranged in the supporting grooves, and the first wheels are configured for supporting the supporting shafts.

As an improvement of the present disclosure, the base is further provided with a recessed portion recessed in a direction away from the roller. When the roller is supported on the base, a gap exists between the roller and an inner wall of the recessed portion, and the recessed portion is provided with a second wheel.

As an improvement of the present disclosure, the third opening is arranged at the recessed portion.

As an improvement of the present disclosure, a mounting groove is defined under the supporting groove. The mounting groove is in communication with the supporting groove. The driving gear is arranged in the mounting groove. An inner wall of the mounting groove is provided with a fourth opening, and the mounting groove is in communication with the outside via the fourth opening.

As an improvement of the present disclosure, the fecal collection box is further provided with a first avoidance groove, and the first avoidance groove is configured for accommodating the first rack and the second rack.

As an improvement of the present disclosure, the fecal collection box is provided with a first outer side wall and a first bottom wall. The first bottom wall is connected to the first outer side wall. A distance between a first side of the first bottom wall and a bottom end of the first outer side wall is defined as a first distance. A distance between a second side of the first bottom wall and the bottom end of the first outer side wall is defined as a second distance. The first distance is different from the second distance, so that the first bottom wall is arranged at an inclined angle.

As an improvement of the present disclosure, the base is provided with a locking device, the locking device is configured for locking the fecal collection box detachably under the base.

As an improvement of the present disclosure, a plurality of protruding frames are arranged in the first accommodation space.

As an improvement of the present disclosure, the pet toilet further includes a cushion body. The cushion body is configured for detachably covering the frames and a bottom surface of the first accommodation space.

As an improvement of the present disclosure, the cushion body is engaged with an inner wall of the roller in a snap-fit manner. The cushion body is provided with a snap-fit portion, and the inner wall of the roller is provided with a snap-fit engaging portion. The snap-fit portion is detachably connected to the snap-fit engaging portion.

As an improvement of the present disclosure, a circular leak-proof ring is arranged in the first accommodation space. The circular leak-proof ring is configured for blocking the excrement of pets in the first accommodation space.

Beneficial effects of the present disclosure are as follows. The present disclosure provides a pet toilet. Through the aforementioned structure, when the roller rotates from the original position towards the defecation position, the pet litter is capable of entering the third accommodation space through the sieve component, and the excrement is confined outside the third accommodation space, so as to achieve sieving of the pet litter and pet excrement. In addition, the sealing door is configured to open the second opening, and the first opening rotates along with the roller to be aligned with the second opening. In this way, the excrement is capable of being discharged by its own gravity into the second accommodation space through the first opening and the second opening, thereby completing separation and collection of the excrement. When the excrement is discharged into the second accommodation space of the fecal collection box, and when the roller rotates from the defecation position towards the original position, the pet litter in the third accommodation space is capable of passing through the sieve component and falling back into the first accommodation space by its own gravity. In addition, the sealing door is configured to close the second opening, so as to seal the excrement within the fecal collection box and prevent odor of the excrement from emitting into residential environment.

### BRIEF DESCRIPTION OF THE DRAWINGS

Implementations of the present disclosure will now be described, by way of embodiment, with reference to the attached figures. It should be understood, the drawings are shown for illustrative purpose only, for ordinary person skilled in the art, other drawings obtained from these drawings without paying creative labor by an ordinary person skilled in the art should be within scope of the present disclosure.

FIG. 1 is an overall structural diagram of a roller of the present disclosure in an original position;

FIG. 2 is an overall structural diagram of the roller of the present disclosure in a defecation position;

FIG. 3 is an enlarged view of area A in FIG. 2;

FIG. 4 is an exploded view of the roller and a base;

FIG. 5 is an exploded view of a fecal collection box;

FIG. 6 is an enlarged view of area B in FIG. 5;

FIG. 7 is an overall structural diagram of the present disclosure;

FIG. 8 is an enlarged view of area C in FIG. 7;

FIG. 9 is an enlarged view of area G in FIG. 7;

FIG. 10 is another overall structural diagram of the present disclosure;

FIG. 11 is an enlarged view of area D in FIG. 10;

FIG. 12 is an enlarged view of area E in FIG. 10;

FIG. 13 is a structural diagram of a sieve component;

FIG. 14 is a sectional view taken along the roller, the base, and the fecal collection box when the roller is in the original position;

FIG. 15 is an enlarged view of area H in FIG. 14;

FIG. 16 is a sectional view taken along the roller, the base, and the fecal collection box when the roller is in the defecation position;

FIG. 17 is an enlarged view of area F in FIG. 16;

FIG. 18 is a sectional view taken along a sealing door and a supporting arm;

FIG. 19 is an enlarged view of area L in FIG. 18;

FIG. 20 is an enlarged view of area K in FIG. 18;

FIG. 21 is a sectional view taken along a casing;

FIG. 22 is a structural diagram of an arc-shaped sealing door;

FIG. 23 is an exploded view of the structural diagram of the arc-shaped sealing door;

FIG. 24 is a sectional view taken along the arc-shaped sealing door;

FIG. 25 is a structural diagram of a base with a second safety notch;

FIG. 26 is an exploded view of the base with the second safety notch;

FIG. 27 is a sectional view taken along the second safety notch;

FIG. 28 is yet another overall structural diagram of the present disclosure;

FIG. 29 is yet another exploded view of the present disclosure.

### DETAILED DESCRIPTION OF THE EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. In addition, the terms “first” and “second” are used for descriptive purposes only and cannot be understood as indicating or implying relative importance or implying the number of indicated technical features. Thus, the features defined as “first” and “second” may explicitly or implicitly include one or more of the features. In the description of embodiments of the application, “a plurality of” means two or more, unless otherwise specifically defined.

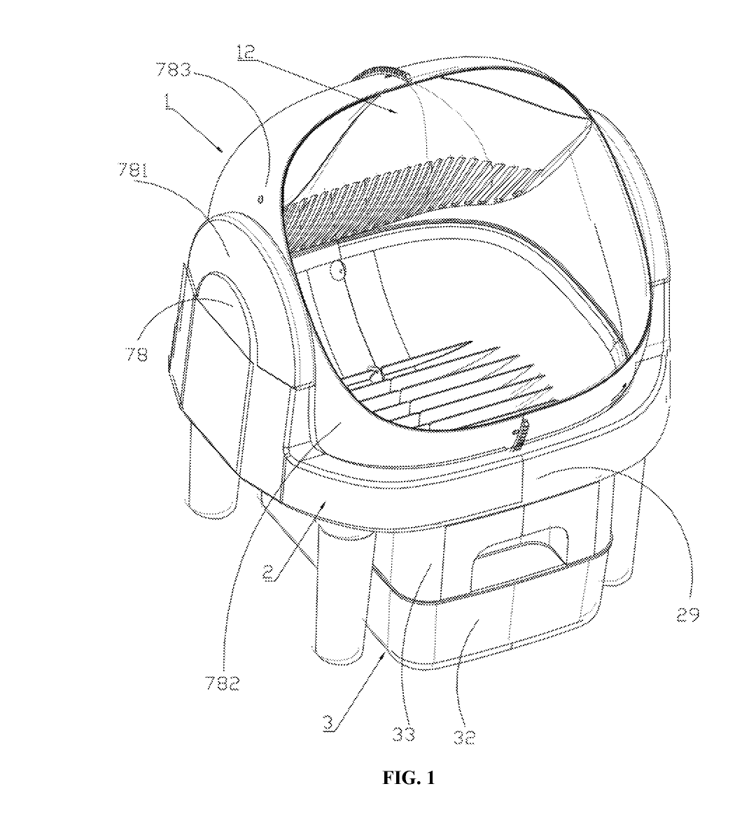

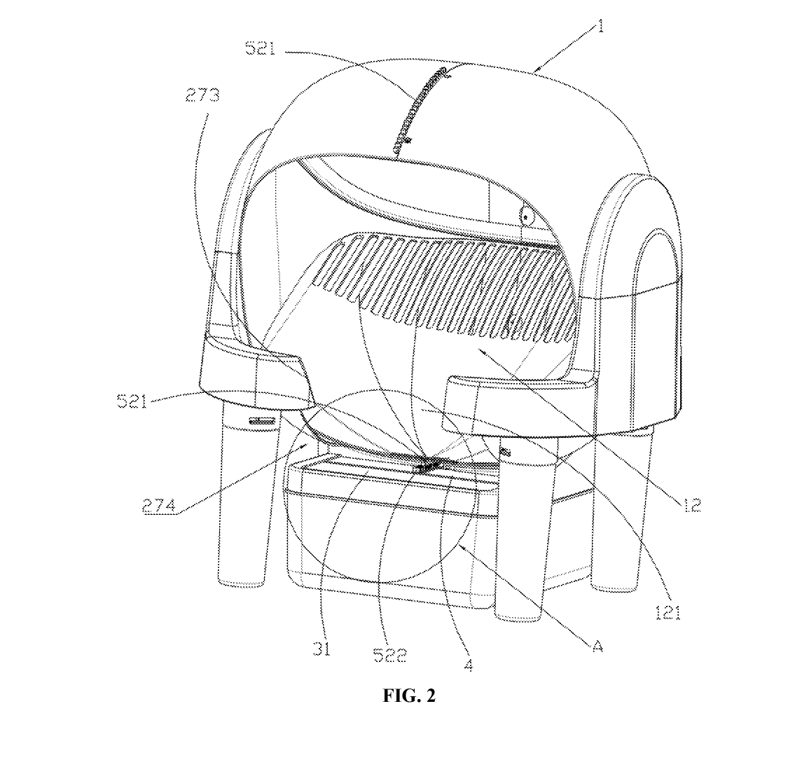

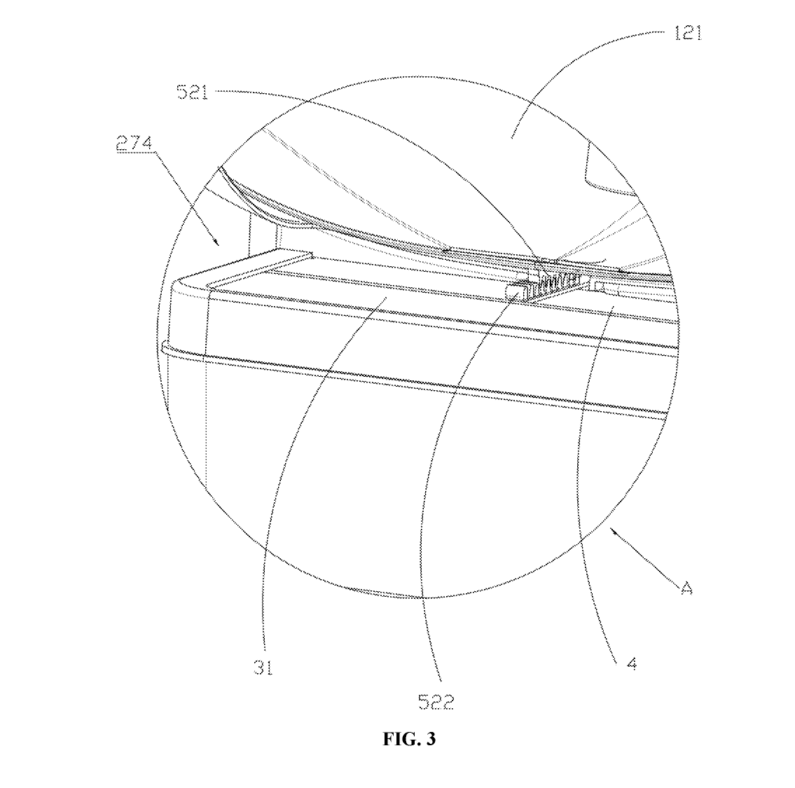

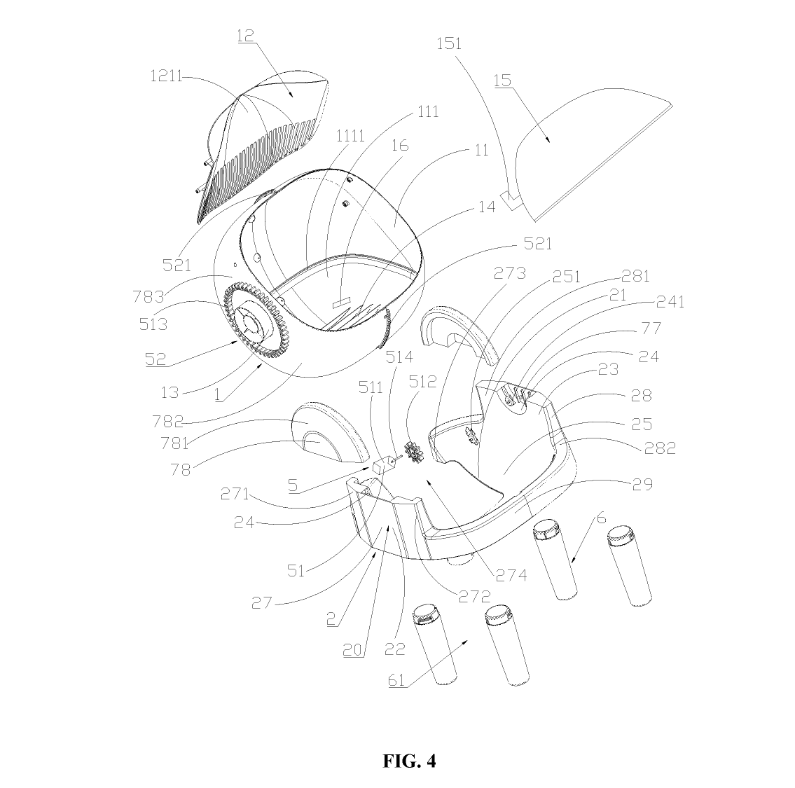

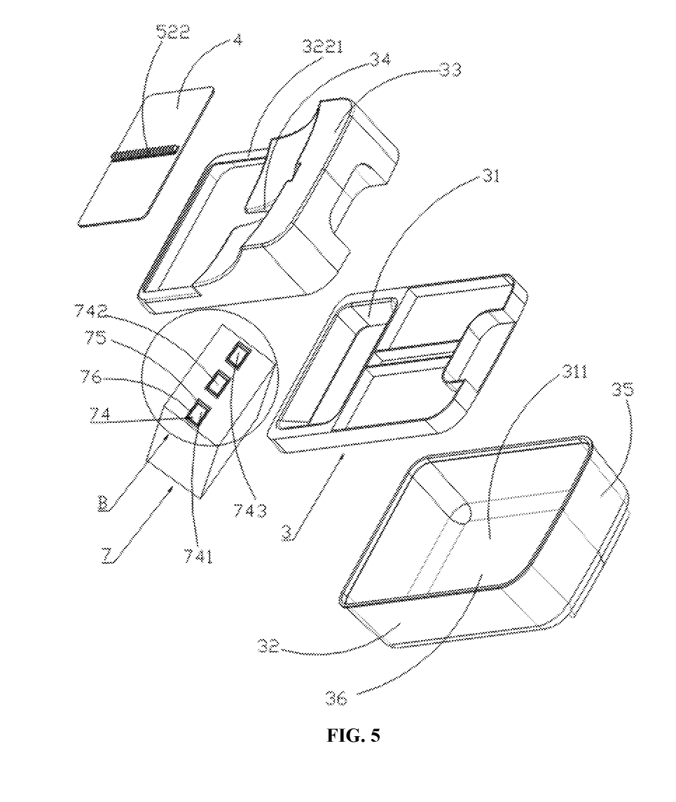

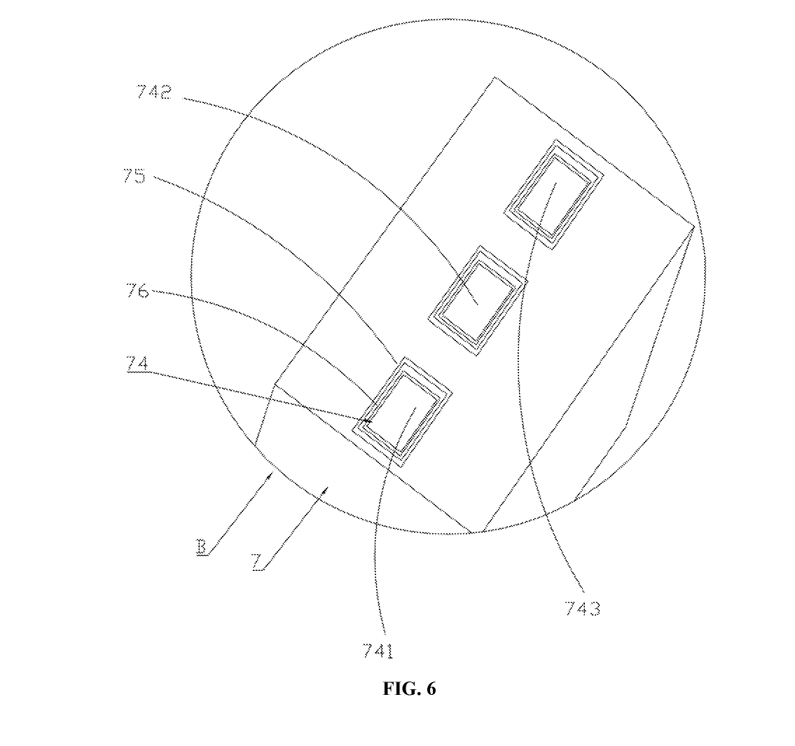

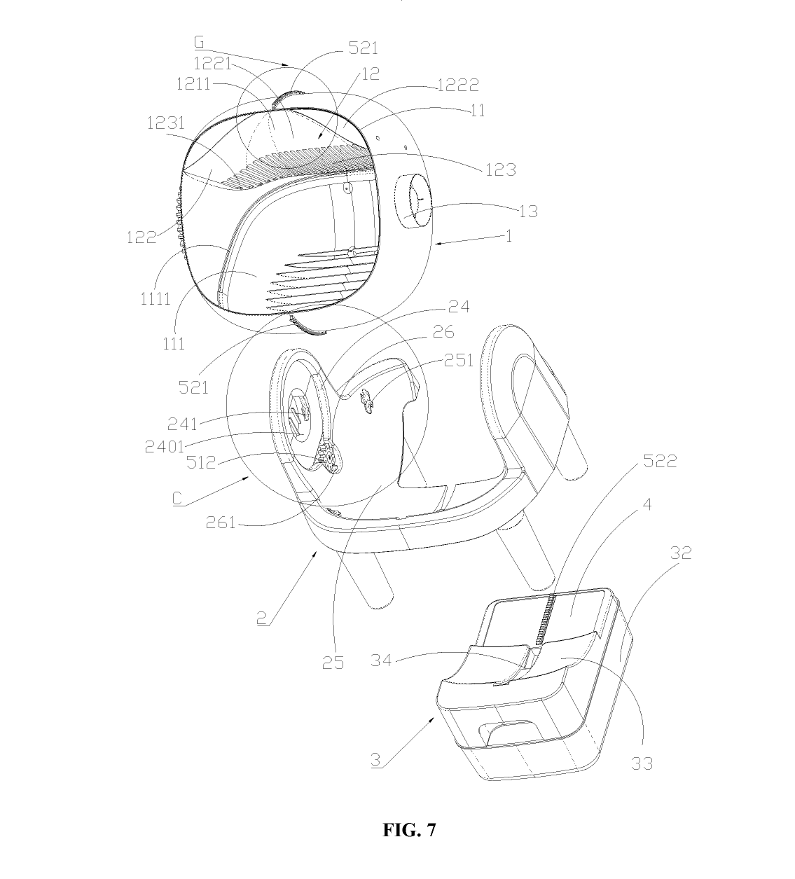

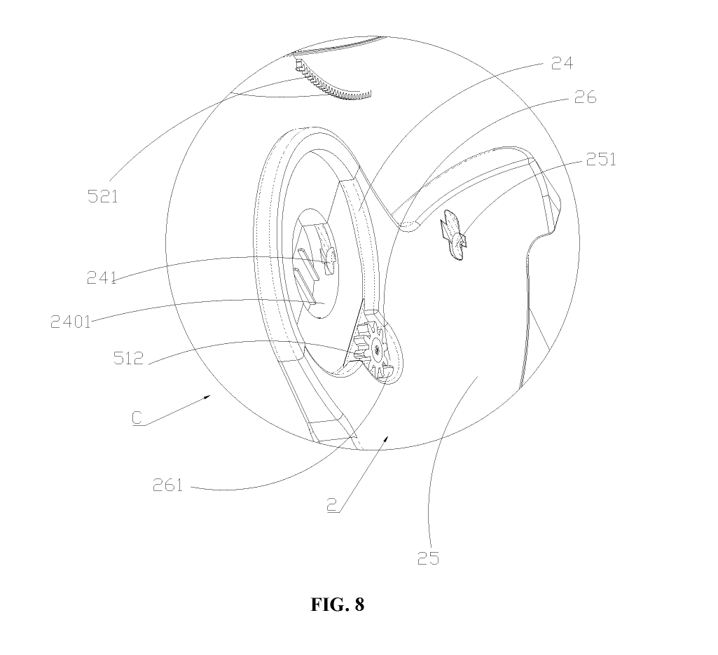

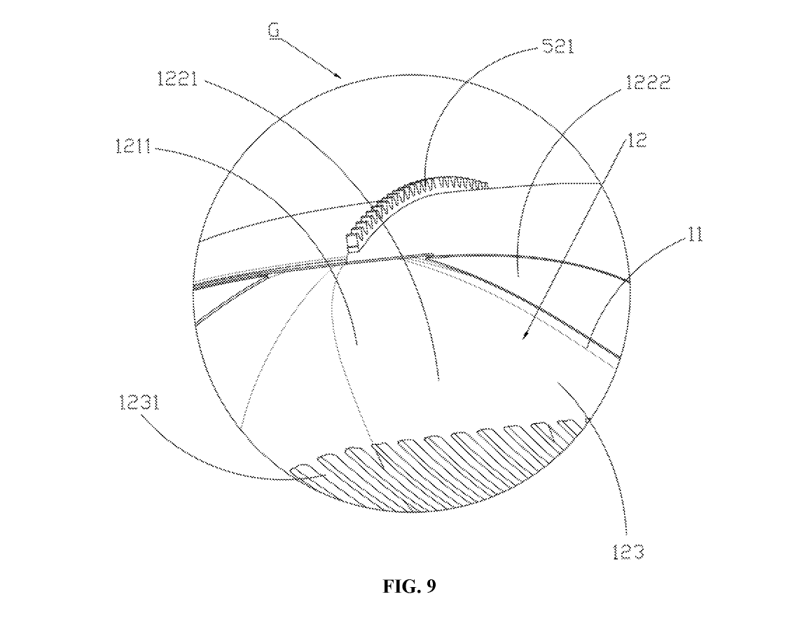

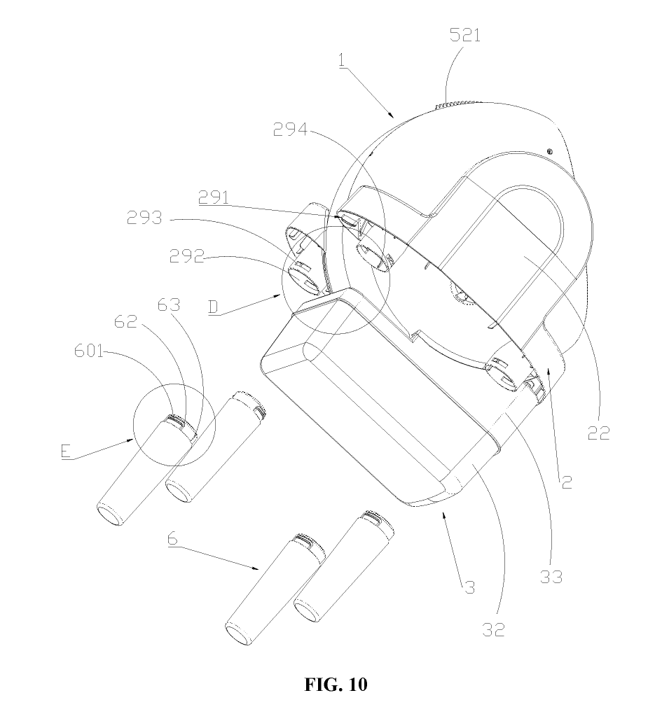

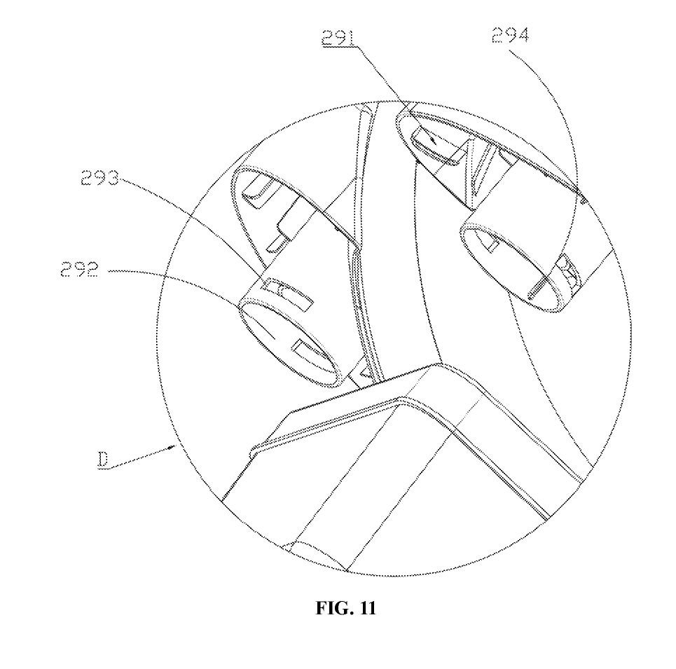

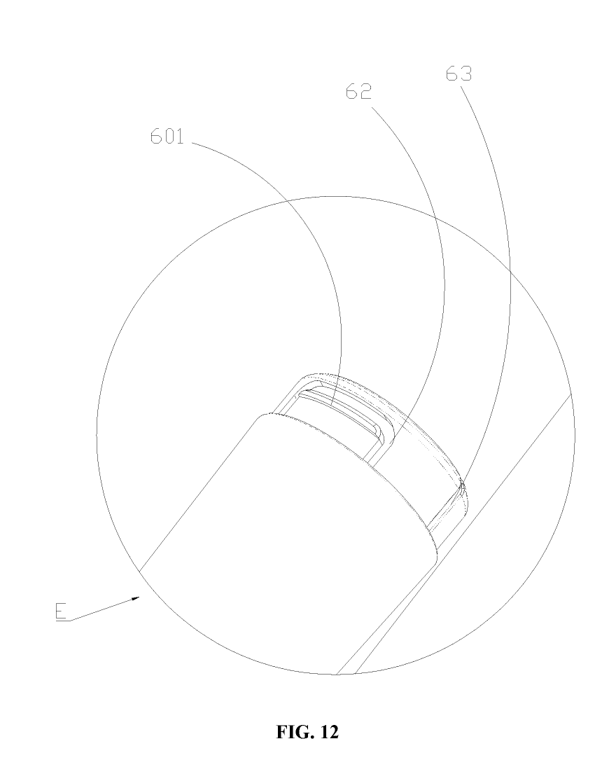

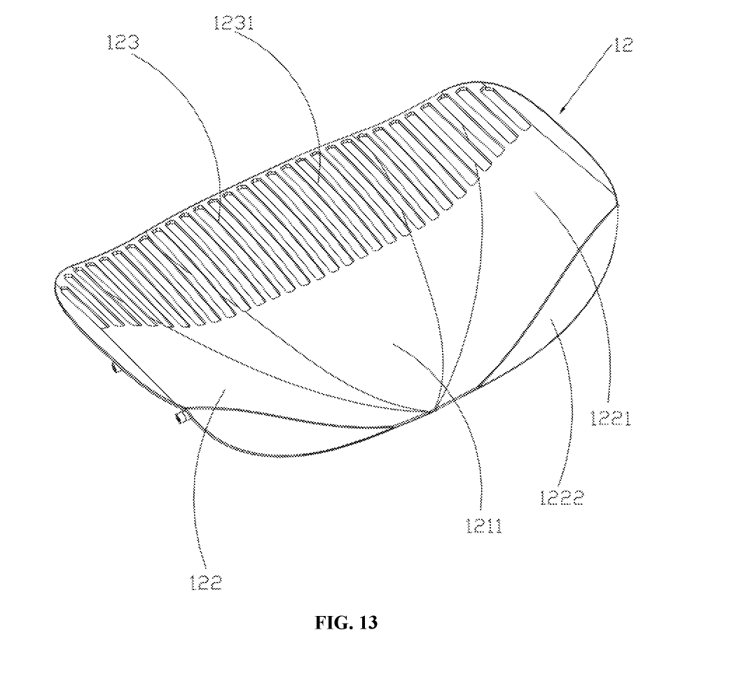

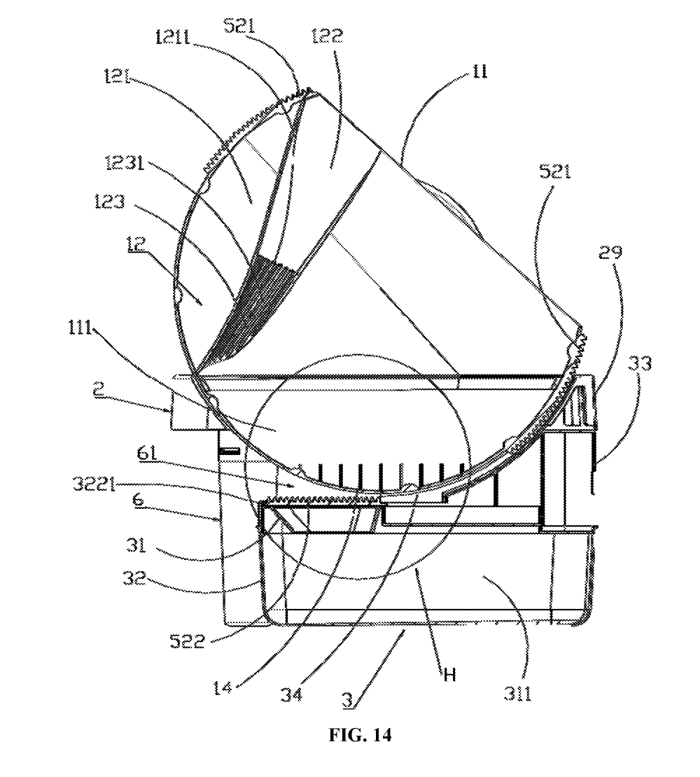

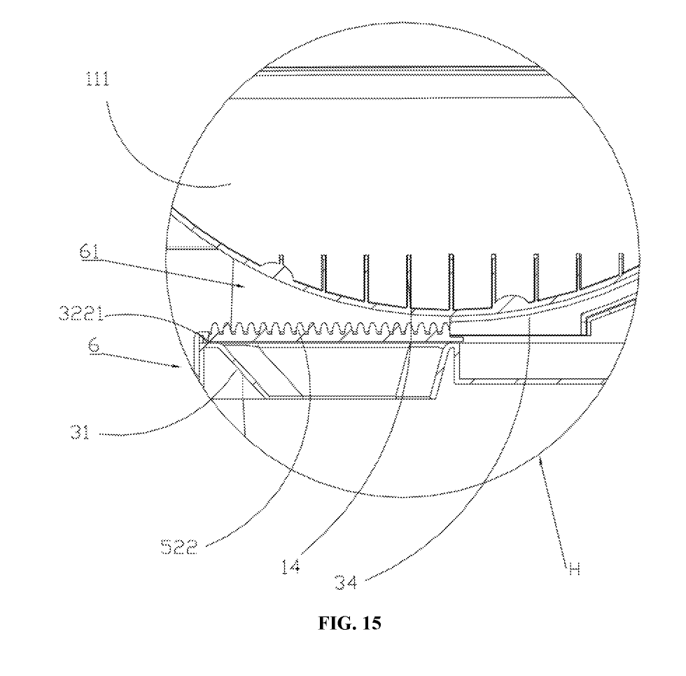

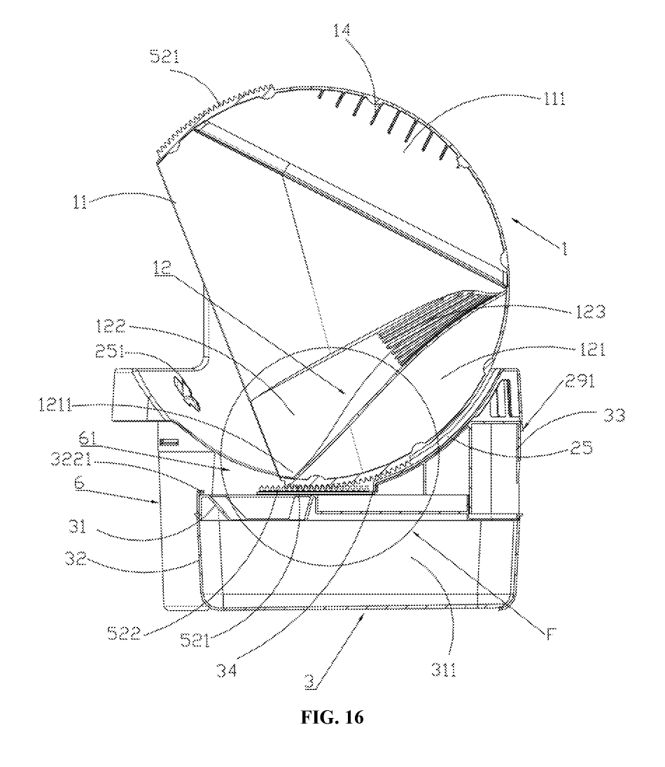

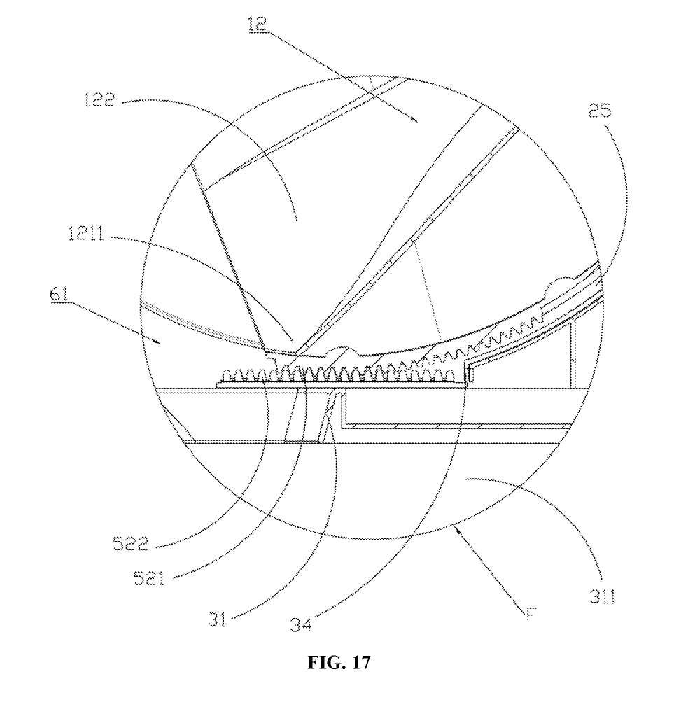

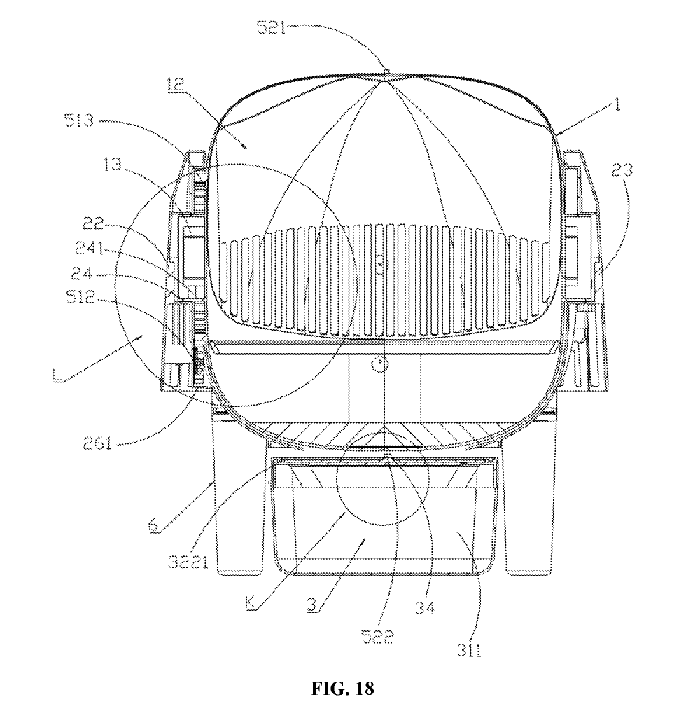

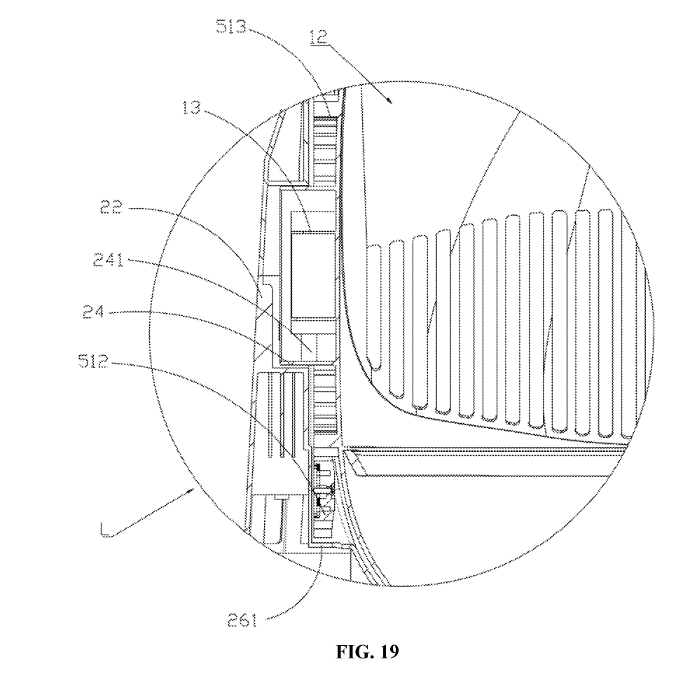

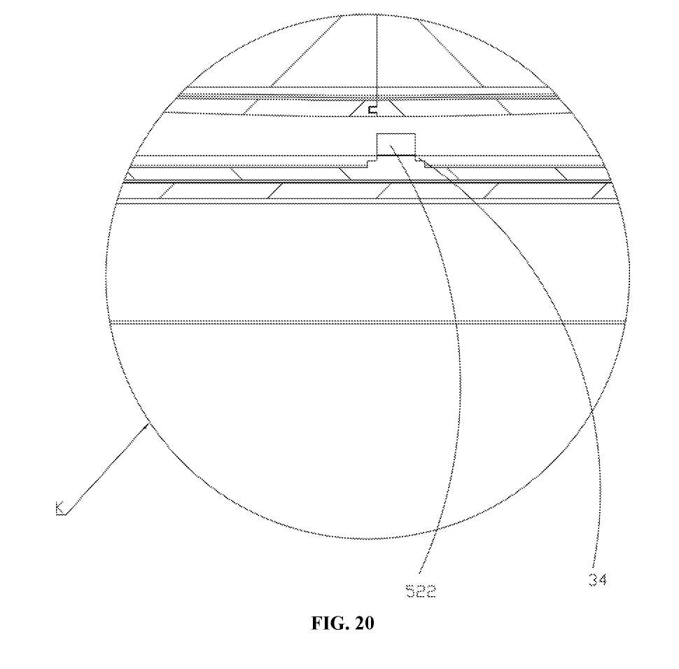

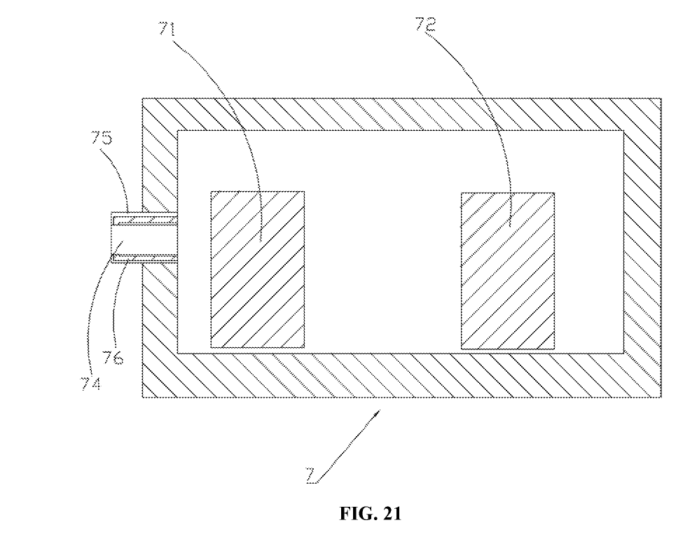

Referring to FIGS. 1-21, the present disclosure provides a pet toilet.

The pet toilet includes a roller 1. The roller 1 is provided with a first opening 11 and a first accommodation space 111. The first opening 11 is in communication with the first accommodation space 111. The first accommodation space 111 is configured for accommodating excrement of pets and pet litter.

The pet toilet further includes a base 2, and the base 2 is configured for supporting the roller 1.

The pet toilet further includes a fecal collection box 3, and the fecal collection box 3 is arranged under the base 2. The fecal collection box 3 is provided with a second accommodation space 311 and a second opening 31. The second opening 31 is in communication with the second accommodation space 311.

The pet toilet further includes a sealing door 4, and the sealing door 4 is arranged at the second opening 31.

The pet toilet further includes a sieve component 12, and the sieve component 12 is connected to the roller 1. The sieve component 12 and an inner wall of the roller 1 are configured to surround to form a third accommodation space 121. The third accommodation space 121 is adjacent to the first accommodation space 111. The sieve component 12 is configured for sifting the pet litter from the excrement.

The pet toilet further includes a drive device 5, and the drive device 5 is configured for driving the roller 1 to rotate on the base 2. When the first opening 11 rotates along with the roller 1 from an original position towards a defecation position, the pet litter is capable of entering the third accommodation space 121 through the sieve component 12, and the excrement is confined outside the third accommodation space 121. In addition, the sealing door 4 is configured to open the second opening 31. The first opening 11 is configured to rotate along with the roller 1 to be aligned with the second opening 31, so that the excrement is capable of being discharged into the second accommodation space 311 by its own gravity through the first opening 11 and the second opening 31. When the first opening 11 rotates along with the roller 1 from the defecation position towards the original position, the pet litter in the third accommodation space 121 is capable of passing through the sieve component 12 and falling back into the first accommodation space 111 by its own gravity. In addition, the sealing door 4 is configured to close the second opening 31.

Through the above structure, when the roller 1 rotates from the original position towards the defecation position, the pet litter is capable of entering the third accommodation space 121 through the sieve component 12, and the excrement is confined outside the third accommodation space 121, thereby realizing sieving of the pet litter and pet excrement. The sealing door 4 opens the second opening 31, the first opening 11 rotates along with the roller 1 to be aligned with the second opening 31, such that the excrement is capable of being discharged by its own gravity into the second accommodation space 311 through the first opening 11 and the second opening 31, thereby completing separation and collection of the excrement. When the excrement is discharged into the second accommodation space 311 of the fecal collection box 3, and when the roller 1 rotates from the defecation position towards the original position, the pet litter in the third accommodation 121 is capable of passing through the sieve component 12 and falling back into the first accommodation space 111 by its own gravity, and the sealing door 4 closes the second opening 31, so as to close the excrement in the fecal collection box 3 and prevent odor of the excrement from emitting into residential environment.

In the present embodiment, when the first opening 11 rotates along with the roller 1 from the original position towards the defecation position, the pet litter is capable of entering the third accommodation space 121 through the sieve component 12, the excrement is confined outside the third accommodation space 121, the drive device 5 drives the sealing door 4 to open the second opening 31, the first opening 11 rotates along with the roller 1 to be aligned with the second opening 31, such that the excrement is capable of being discharged by its own gravity into the second accommodation space 311 through the first opening 11 and the second opening 31. When the first opening 11 rotates along with the roller 1 from the defecation position towards the original position, the pet litter in the third accommodation space 121 is capable of passing through the sieve component 12 and falling back into the first accommodation space 111 by its own gravity, and the drive device 5 drives the sealing door 4 to close the second opening 31. The drive device 5 includes a drive assembly 51 and a transmission assembly 52. The drive device 5 is configured to drive the roller 1 to rotate on the base 2. When the first opening 1 rotates along with the roller 1 from the original position towards the defecation position, the roller 1, through the transmission device 52, drives the sealing door 4 to open the second opening 31, and the first opening 11 rotates along with the roller 1 to be aligned with the second opening 31, such that the excrement is capable of being discharged by its own gravity into the second accommodation space 311 through the first opening 11 and the second opening 31. When the first opening 11 rotates along with the roller 1 from the defecation position towards the original position, the pet litter in the third accommodation space 121 is capable of passing through the sieve component 12 and falling back into the first accommodation space 111 by its own gravity, and the roller 1, through the transmission device 52, drives the sealing door 4 to close the second opening 31. Specifically, the transmission assembly 52 includes a first transmission element 521 and a second transmission element 522, the first transmission element 521 is provided on an outer side wall of the roller 1, and the second transmission element 522 is provided on the sealing door 4. When the first opening 11 rotates along with the roller 1 from the original position towards the defecation position, the first transmission element 521 is connected in transmission with the second transmission element 522, the roller 1, by rotation, drives the first transmission element 521 to rotate, and the first transmission element 521 rotates to drive the second transmission element 522 to move, such that the sealing door 4 moves along with the second transmission element 522 until opening the second opening 31. The first opening 11 rotates along with the roller 1 to be aligned with the second opening 31, such that the excrement is capable of being discharged by its own gravity into the second accommodation space 311 through the first opening 11 and the second opening 31. When the first opening 11 rotates along with the roller 1 from the defecation position towards the original position, the first transmission element 521 is connected in transmission with the second transmission element 522, the pet litter in the third accommodation space 121 is capable of passing through the sieve component 12 and falling back into the first accommodation space 111 by its own gravity, and the first transmission element 521 rotates to drive the second transmission element 522 to move, such that the sealing door 4 moves along with the second transmission element 522 until closing the second opening 31. Furthermore, the fecal collection box 3 is provided with a sliding rail 32, the roller 1, by rotation, drives the first transmission element 521 to rotate, and the first transmission element 521 rotates to drive the second transmission element 522 to move, such that the sealing door 4 slides along with the second transmission element 522 on the sliding rail 32 until opening or closing the second opening 31. Furthermore, the first transmission element 521 is a first arc-shaped rack arranged along an outer circumferential wall of the roller 1, the sealing door 4 is a flat-shaped sealing door 4, the second transmission element 522 is a second flat-shaped rack arranged on the sealing door 4, and the sliding rail 32 is a flat-shaped sliding rail 32. The roller 1, by rotation, drives the first rack to rotate, such that the first rack drives the second rack to move, and the sealing door 4 slides along with the second rack on the sliding rail 32 until opening or closing the second opening 31. Through the above structure, the arrangement of the drive device 5 is effectively realized. The drive assembly 51 drives the roller 1 to rotate on the base 2, and the roller 1, by rotation, drives the first rack to rotate. When the roller 1 rotates from the original position towards the defecation position, the first rack meshes with the second rack, such that the first rack drives the second rack to move. In addition, the sealing door 4 slides along with the second rack on the sliding rail 32 until opening the second opening 31, that is, the sealing door 4 slides along with the second transmission element 522 on the sliding rail 32 until opening the second opening 31, thereby facilitating discharging the excrement by its own gravity into the second accommodation space 311 of the fecal collection box 3 through the first opening 11 and the second opening 31. When the roller 1 rotates from the defecation position towards the original position, the first rack meshes with the second rack, such that the first rack drives the second rack to move. In addition, the sealing door 4 slides along with the second rack on the sliding rail 32 until closing the second opening 31, that is, the sealing door 4 slides along with the second transmission element 522 on the sliding rail 32 until closing the second opening 31, thereby preventing odor of the excrement from emitting into residential environment.

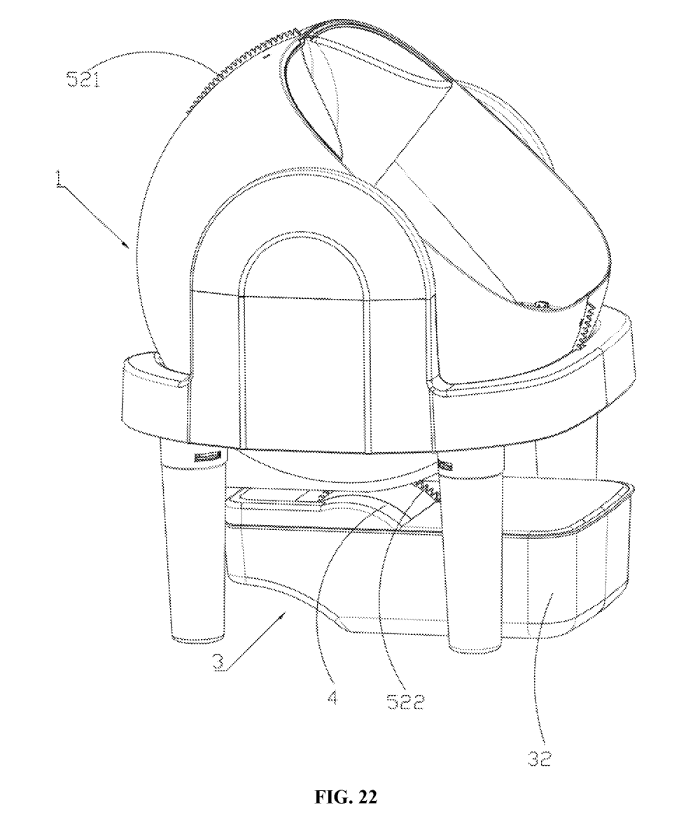

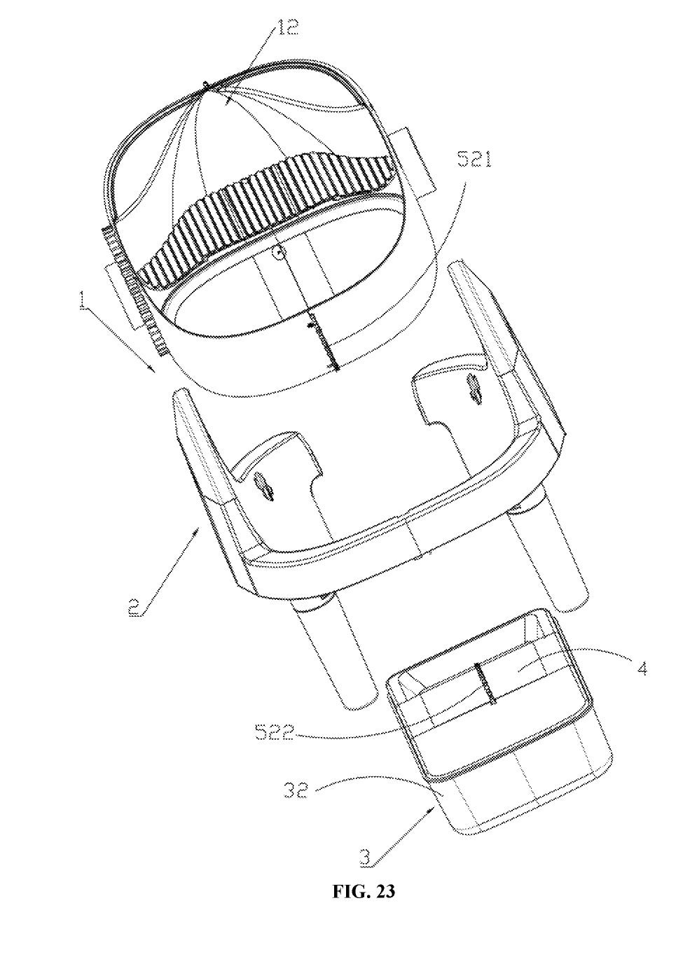

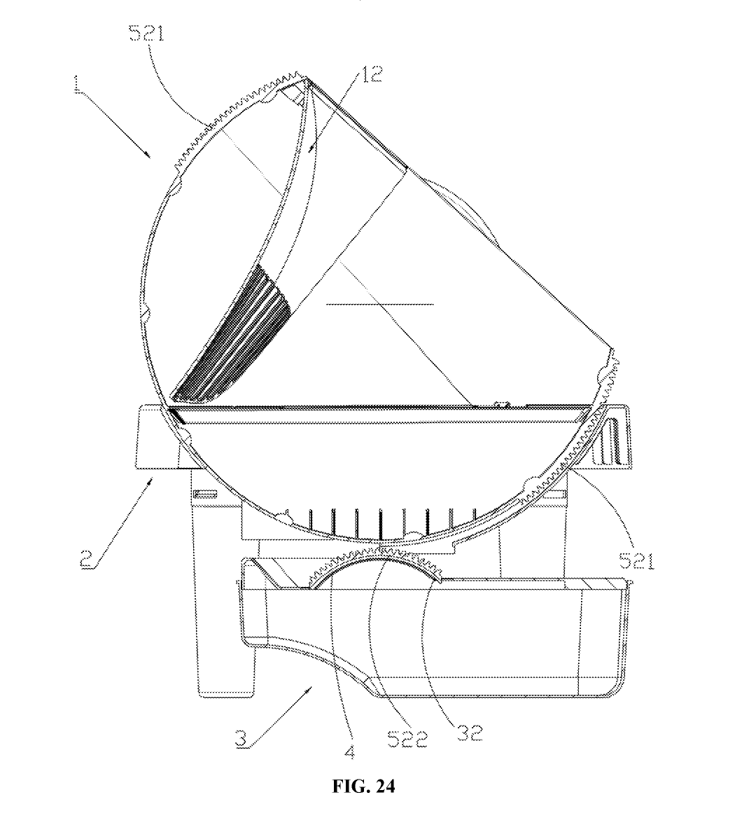

Referring to FIGS. 22-24, in other embodiments, the first transmission element 521 is a first arc-shaped rack arranged along an outer circumferential wall of the roller 1, the sealing door 4 is an arc-shaped sealing door 4, the second transmission element 522 is a second arc-shaped rack arranged on the sealing door 4, and the sliding rail 32 is an arc-shaped sliding rail 32. The roller 1, by rotation, drives the first rack to rotate, such that the first rack drives the second rack to move, and the sealing door 4 slides along with the second rack on the sliding rail 32 until opening or closing the second opening 31.

In the present embodiment, the base 2 is further provided with a third opening 21, and the third opening 21 is located between the roller 1 and the second opening 31. When the first opening 11 rotates along with the roller 1 from the original position towards the defecation position, the pet litter is capable of entering the third accommodation space 121 through the sieve component 12, the excrement is confined outside the third accommodation space 121, and the sealing door 4 opens the second opening 31. The first opening 11 rotates along with the roller 1 to be aligned with the third opening 21 and the second opening 31, such that the excrement is capable of being discharged by its own gravity into the second accommodation space 311 through the first opening 11 and the second opening 31. When the first opening 11 rotates along with the roller 1 from the defecation position towards the original position, the first opening 11 and the second opening 31 are misaligned with the third opening 21, the pet litter in the third accommodation 121 is capable of passing through the sieve component 12 and falling back into the first accommodation space 111 by its own gravity, and the sealing door 4 closes the second opening 31. Through the above structure, the arrangement of the drive device 5 is effectively realized. The drive assembly 51 drives the roller 1 to rotate on the base 2, and the roller 1, by rotation, drives the first rack to rotate. When the roller 1 rotates from the original position towards the defecation position, the first rack meshes with the second rack, such that the first rack drives the second rack to move, and the sealing door 4 slides along with the second rack on the sliding rail 32 until opening the second opening 31. That is, the sealing door 4 slides along with the second transmission element 522 on the sliding rail 32 until opening the second opening 31, thereby facilitating discharging the excrement by its own gravity into the second accommodation space 311 of the fecal collection box 3 through the first opening 11, the third opening 21, and the second opening 31. When the roller 1 rotates from the defecation position towards the original position, the first opening 11 rotates to be misaligned with the second opening 31 and the third opening 21, the first rack meshes with the second rack, such that the first rack drives the second rack to move, and the sealing door 4 slides along with the second rack on the sliding rail 32 until closing the second opening 31. That is, the sealing door 4 slides along with the second transmission element 522 on the sliding rail 32 until closing the second opening 31, thereby preventing odor of the excrement from emitting into residential environment.

In the present embodiment, the drive assembly 5 includes a drive motor 511, a driving gear 512, and a driven gear 513. The drive motor 511 is provided with a drive shaft 514, the driving gear 512 is sleeved on the drive shaft 514, the driven gear 513 is arranged on the roller 1, and the driven gear 513 meshes with the driving gear 512, such that the drive shaft 514 rotates to drive the driving gear 512 to rotate, the driving gear 512 rotates to drive the driven gear 513 to rotate, and the driven gear 513 rotates to drive the roller 1 to rotate on the base 2.

The base 2 is provided with a supporting portion 20, the supporting portion 20 is configured for supporting the roller 1, the supporting portion 20 defines a supporting groove 24, and the driven gear 513 is positioned in the supporting groove 24. A mounting groove 26 is defined under the supporting groove 24, and the mounting groove 26 is in communication with the supporting groove 24. The driving gear 512 is arranged in the mounting groove 26, and at least one portion of the driving gear 512 extends into the supporting groove 24. Specifically, the supporting groove 24 is configured for supporting the roller 1. A first side of the roller 1 is provided with a supporting shaft 13, and a side wall of the supporting groove 24 is recessed to form an annual supporting groove 2401. The supporting shaft 13 is supported within the annual supporting groove 2401, and a lower side of the supporting groove 24 is in communication with the mounting groove 26.

Through the above structure, the supporting groove 24 and the mounting groove 26 are defined in the base 2, and a side wall of the supporting groove 24 is recessed to form an annual supporting groove 2401, so that the supporting shaft 13 arranged at a first side of the roller 1 is supported within the annual supporting groove 2401. In addition, the driven gear 513 is arranged in the supporting groove 24, so that the supporting groove 24 can provide not only stable support for the roller 1, but also a reasonable meshing space for the driving gear 512 and the driven gear 513. The structural arrangement is more compact and orderly, thereby facilitating the centralized arrangement of the transmission structure and improving the overall structural stability.

In the present embodiment, the supporting portion 20 includes a first supporting arm 22 arranged on a first side of the base 2 and includes a second supporting arm 23 arranged on a second side of the base 2. The first supporting arm 22 and the second supporting arm 23 are both provided with a supporting groove 24. Both sides of the roller 1 are provided with supporting shafts 13, the supporting shafts 13 are located in the supporting grooves 24, each supporting groove 24 is provided with a plurality of first wheels 241, and the first wheels 241 are configured for supporting the supporting shafts 13. Specifically, the base 2 is further provided with a recessed portion 25 recessed in a direction away from the roller 1. When the roller 1 is supported on the base 2, there is a gap between the roller 1 and an inner wall of the recessed portion 25, and the recessed portion 25 is provided with a second wheel 251. Furthermore, the third opening 21 is arranged in the recessed portion 25. Through the above structure, when the driving gear 512 drives the driven gear 513 and the roller 1 to rotate, the supporting shafts 13 are supported by the first wheels 241, such that the roller 1 rotates on the supporting arms of the base 2 through the supporting shafts 13, and transmission efficiency is effectively improved. Moreover, a weight of the roller 1 is concentrated on the supporting arms at two sides of the base 2, the weight of the roller 1 can be prevented from being concentrated on the recessed portion 25, and the roller 1 is prevented from squeezing the recessed portion 25 to cause deformation and damage of the base 2. Furthermore, since the gap exists between the roller 1 and an inner wall of the recessed portion 25, and the recessed portion 25 is provided with the second wheel 251. When weight carried inside the roller 1 is large, for example, the pet litter stored in the roller 1 is too much, the outer wall of the roller 1 will deform under the action of gravity, the gap existing between the roller 1 and an inner wall of the recessed portion 25 can also further prevent the weight of the roller 1 from being concentrated on the recessed portion 25. Moreover, the gap can prevent the roller 1 from squeezing the recessed portion 25 to cause deformation and damage of the base 2. Furthermore, the second wheel 1 in the recessed portion 25 can assist the roller 1 in rotation, such that the roller 1 can rotate on the supporting arms of the base 2 more smoothly.

In the present embodiment, an inner wall of the mounting groove 26 is provided with a fourth opening 261, and the mounting groove 26 is in communication with the outside through the fourth opening 261. Through the above structure, if pet litter enters the supporting groove 24 and the mounting groove 26, the pet litter can be discharged to the outside through the fourth opening 261. This effectively prevents the pet litter from blocking in the supporting groove 24 and the mounting groove 26, such that the pet litter is prevented from jamming the driving gear 512 and the driven gear 513, and the roller 1 can rotate more smoothly on the supporting arms.

In the present embodiment, the pet toilet further includes supporting legs 6. The supporting legs 6 are connected to the base 2 and used to support the base 2. A fourth accommodation space 61 is formed among bottom ends of the supporting legs 6 and the base 2, and the fecal collection box 3 is arranged in the fourth accommodation space 61. The base 2 includes a left side wall 27, a right side wall 28, and a connection wall 29 connecting the left side wall 27 with the right side wall 28. The first supporting arm 22 is arranged on the left side wall 27, and the second supporting arm 23 is arranged on the right side wall 28. The left side wall 27 has a first end 271 and a second end 272, the right side wall 28 has a third end 281 and a fourth end 282, and a first safety notch 273 is formed between the first end 271 of the left side wall 27 and the third end 281 of the right side wall 28, such that an open first safety space 274 is formed between the base 2 and the roller 1.

Through the above structure, when the roller 1 rotates on the base 2, if there is a pet in the first safety space 274 between the base 2 and the roller 1, the pet can escape through the first safety notch 273, so that the pet can be prevented from being pinched by the base 2 and the rotating roller 1.

In the present embodiment, the first supporting arm 22 is located between the first end 271 and the third end 281, and the second supporting arm 23 is located between the second end 272 and the fourth end 282.

The second end 272 of the left side wall 27 is connected to the fourth end of the right side wall 28. Specifically, the fecal collection box 3 includes an accommodation box body 32 and a filling protrusion 33, the filling protrusion 33 is connected to the accommodation box body 32, and the filling protrusion 33 is configured to fill a gap between the connection wall 29 and the accommodation box body 32. Through the above structure, the filling protrusion 33 can fill the gap between the connection wall 29 and the accommodation box body 32, so as to prevent pets from entering the gap, and thereby prevent pets from being pinched by the base 2 and the rotating roller 1. Furthermore, the supporting legs 6 are further included. The supporting legs 6 are connected to the base 2 and used to support the base 2. The fourth accommodation space 61 is formed among bottom ends of the supporting legs 6 and the base 2, and the fecal collection box 3 is arranged in the fourth accommodation space 61. The base 2 includes the left side wall 27, the right side wall 28, and the connection wall 29 connecting the left side wall 27 with the right side wall 28. The first supporting arm 22 is arranged on the left side wall 27, and the second supporting arm 23 is arranged on the right side wall 28. The left side wall 27 has the first end 271 and the second end 272, the right side wall 28 has the third end 281 and the fourth end 282, and the first safety notch 273 is formed between the first end 271 of the left side wall 27 and the third end 281 of the right side wall 28, such that the open first safety space 274 is formed between the base 2 and the roller 1. The fecal collection box 3 includes the accommodation box body 32 and the filling protrusion 33, the filling protrusion 33 is connected to the accommodation box body 32, and the filling protrusion 33 is configured to fill the gap between the connection wall 29 and the accommodation box body 32. The fecal collection box 3 is further provided with a first avoidance groove 34, the first avoidance groove 34 extends corresponding to the filling protrusion 33, and the first avoidance groove 34 is configured to accommodate the first rack and the second rack. Through the above structure, the first avoidance groove 34 can avoid the first rack and the second rack, the second rack and the sealing door 4 can slide on the sliding rail 32 more smoothly, and the first rack can also rotate along with the roller 1 more smoothly, thereby driving the second rack and the sealing door 4 to slide.

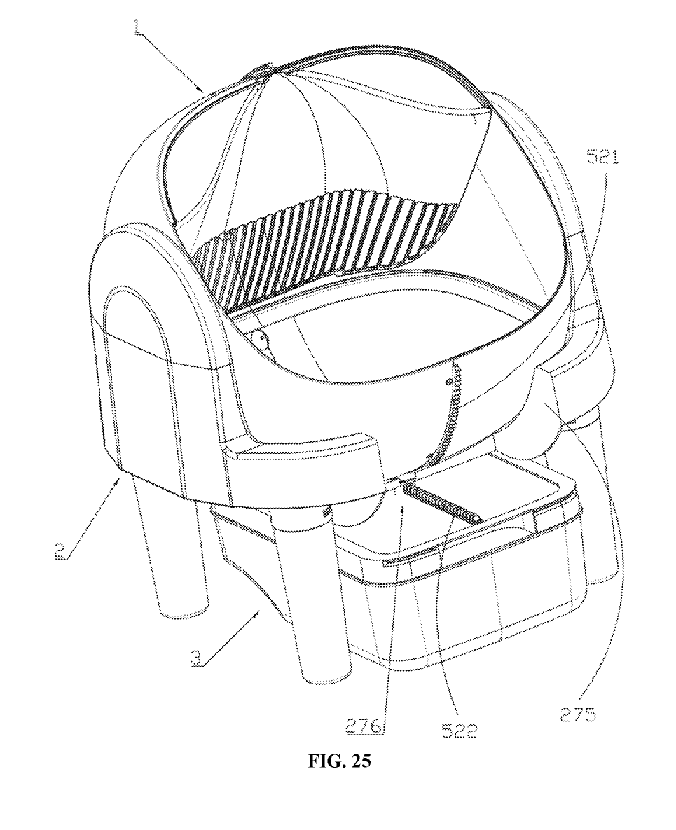

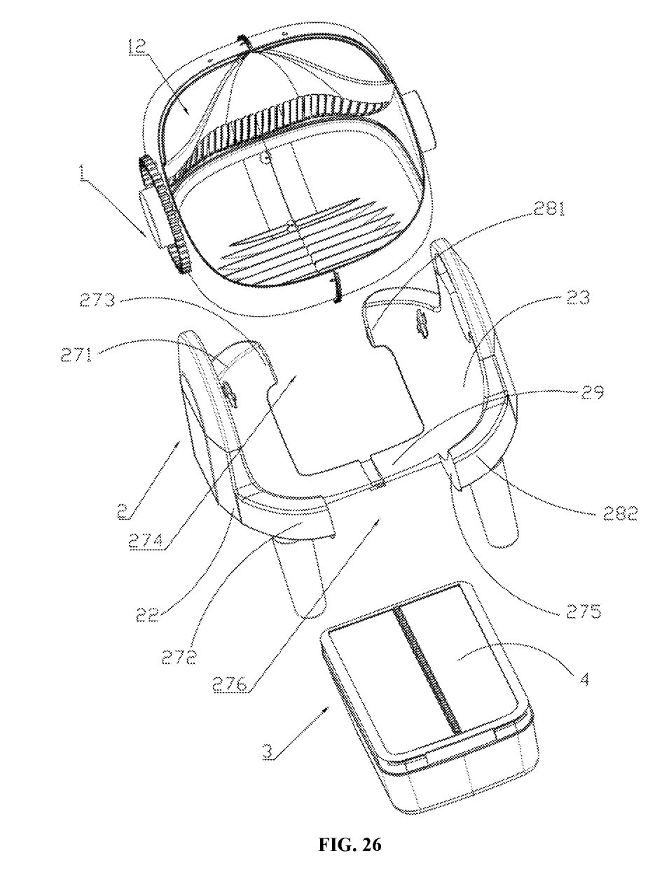

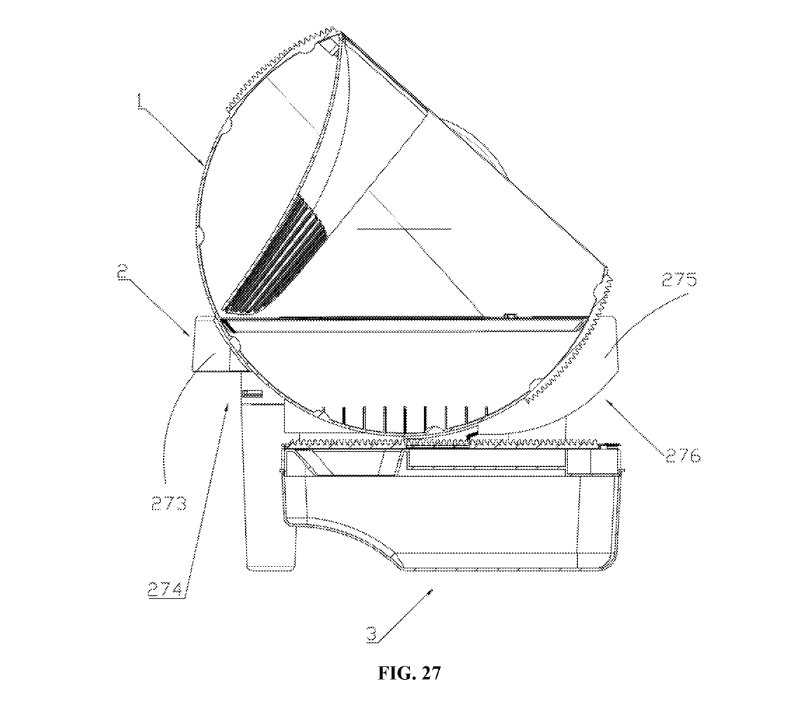

Referring to FIGS. 25-27, in other embodiments, it is possible to connect a middle part of the left side wall 27 and a middle part of the right side wall 28 through the connection wall 29, such that a second safety notch 275 is formed between the second end 272 of the left side wall 27 and the fourth end 282 of the right side wall 28, and an open second safety space 276 is formed between the base 2 and the roller 1. when the roller 1 rotates on the base 2, if there is a pet in the second safety space 276 between the base 2 and the roller 1, the pet can escape through the second safety notch 275, thus the pet can be prevented from being pinched by the base 2 and the rotating roller 1. Moreover, the fecal collection box 3 is further provided with the first avoidance groove 34, and the first avoidance groove 34 is configured to avoid the first rack and the second rack.

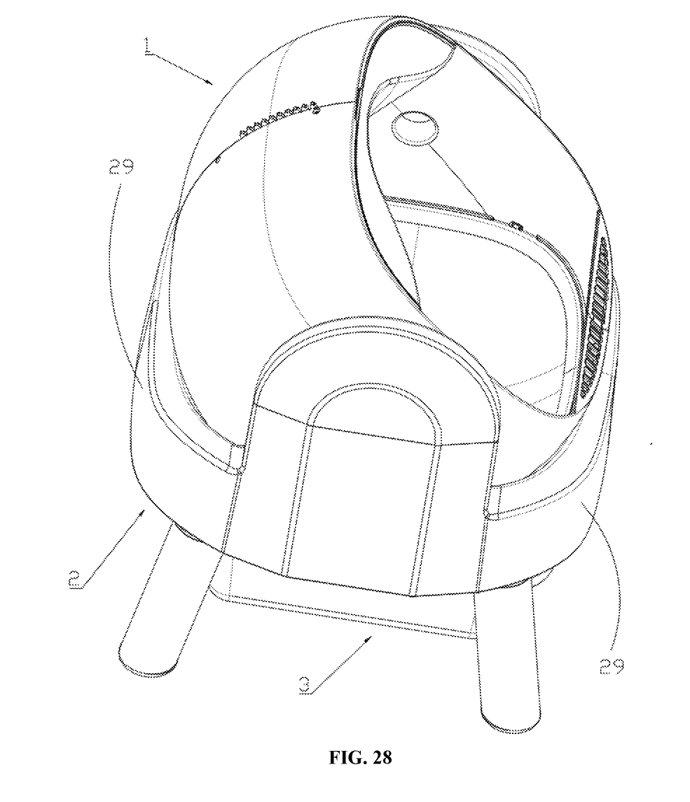

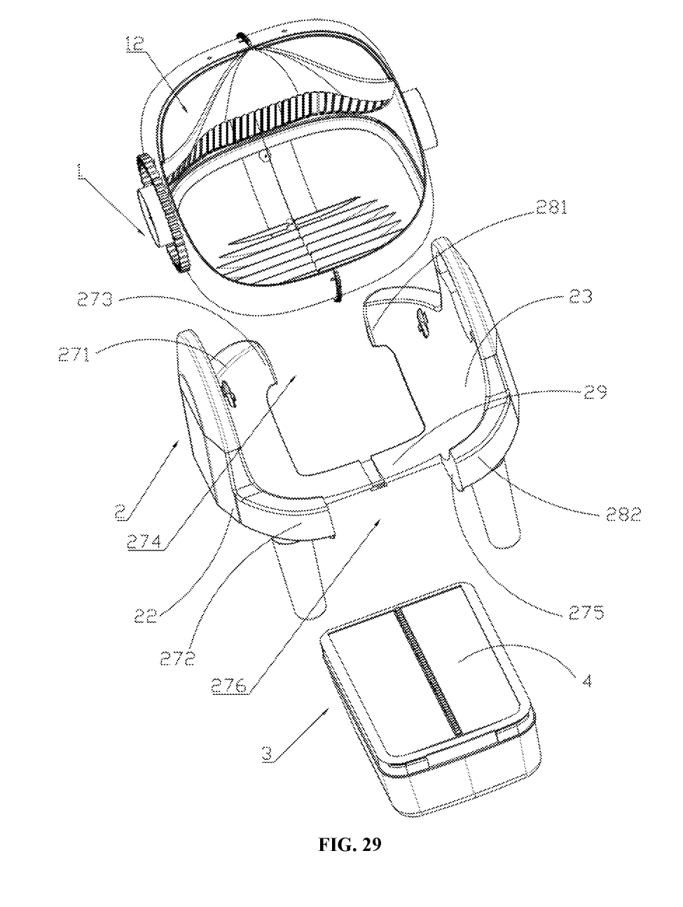

Referring to FIGS. 28 and 29, in other embodiments, in order to improve stability of the base 2, it is also possible to connect the first end 271 of the left side wall 27 with the third end 281 of the right side wall 28 through the connection wall 29, and connect the second end 272 of the left side wall 27 with the fourth end 282 of the right side wall 28 through the connection wall 29, thereby enhancing the stability of the base 2.

In the present embodiment, the fecal collection box 3 has a first outer side wall 35 and a first bottom wall 36, and the first bottom wall 36 is connected with the first outer side wall 35. A distance between a first side of the first bottom wall 36 and a bottom end of the first outer side wall 35 is defined as a first distance, and a distance between a second side of the first bottom wall 36 and the bottom end of the first outer side wall 35 is defined as a second distance. The first distance is different from the second distance, such that the first bottom wall 36 is arranged at an inclined angle. The second distance is larger than the first distance, and the second opening 31 is arranged above the second side of the first bottom wall 36. Through the above structure, when excrement is discharged into the second accommodation space 311 of the fecal collection box 3 through the second opening 31, the excrement can slide along the inclined surface from the second side of the first bottom wall 36 to the first side of the first bottom wall 36, thereby preventing the excrement from stacking at the second side of the first bottom wall 36 under the second opening 31.

In the present embodiment, a locking device 291 is arranged on the base 2, and the locking device 291 is configured to lock the fecal collection box 3 detachably under the base 2. The locking device 291 is a locking elastic buckle. Through the above structure, it is possible to detach the fecal collection box 3 by toggle the elastic buckle, and it is convenient for users to remove excrement in the fecal collection box 3 and convenient for users to clean the fecal collection box 3.

In the present embodiment, a plurality protruding frames 14 are arranged in the first accommodation space 111. The pet toilet further includes a cushion body 15, and the cushion body 15 detachably covers the frames 14 and a bottom surface of the first accommodation space 111. Through the above structure, the protruding frames 14 can support the cushion body 15, such that the cushion body 15 is higher than the bottom surface of the first accommodation space 111. Therefore, it is possible to reduce volume of the first accommodation space 111 by placing pet litter on the cushion body 15, and it is convenient for users to adjust use amount of pet litter. When required amount of the pet litter is large, the cushion body 15 can be detached, such that pet litter is directly placed on the bottom surface of the first accommodation space 111, thereby enlarging the volume of the first accommodation space 111.

In the present embodiment, the cushion body 15 is engaged with an inner wall of the roller 1 in a snap-fit manner. The cushion body 15 is provided with a snap-fit portion 151, the inner wall of the roller 1 is provided with a snap-fit engaging portion 16, and the snap-fit portion 151 is detachably connected to the snap-fit engaging portion 16. Through the above structure, it is convenient for users to assemble or detach the cushion body 15 in the first accommodation space 111.

Specifically, a circular leak-proof ring 1111 is arranged in the first accommodation space 111, and the circular leak-proof ring 1111 is configured to block the excrement of pets in the first accommodation space 111. Through the above structure, when the roller 1 rotates, the circular leak-proof ring 1111 can prevent excrement, such as urine, in the first accommodation space 111 from leaking out of the first accommodation space 111.

In the present embodiment, the supporting legs 6 are detachably connected to the base 2. The supporting legs 6 are connected to the base 2 by buckle. Specifically, the base 2 is provided with insertion openings 292, an inner wall of each insertion opening 292 is provided with a plurality of clamping gaps 293, and an outer side wall of each supporting leg 6 is provided with a plurality of buckles 601. When the supporting leg 6 is inserted in the insertion opening 292, the buckles 601 are connected with the clamping gaps 293, such that the supporting leg 6 and the base 2 are combined as a whole. Furthermore, a lower side of each buckle 601 is connected to the outer side wall of the supporting leg 6, and there is a slit 62 existing between the buckle 601 and the outer side wall of the supporting leg 6. The slit 62 is arranged to surround a top side, a left side, and a right side of the buckle 601. Furthermore, each insertion opening 292 is further provided with a first guide part 294, and each supporting leg 6 is further provided with a second guide part 63. When the supporting leg 6 is inserted into the insertion opening 292, the first guide part 294 slides along the second guide part 293, such that the buckles 601 are connected with the clamping gaps 293, and the supporting leg 6 and the base 2 are combined as a whole. Furthermore, the first guide part 294 is a guide block arranged on an inner side of the insertion opening 292, and the second guide part 63 is a guide groove arranged on a side wall of the supporting leg 6. Through the above structure, it is convenient for the supporting legs 6 to be mounted to or detached from the base 2. When it is required to support the base 2 by the supporting legs 6 and to use the pet toilet, the guide groove is driven to slide along the guide block, such that the buckles 601 slide to clamping gaps 293 and are connected to the clamping gaps 293, and the supporting legs 6 are mounted to the base 2. When it is required to retract and transport the pet toilet, it is possible to detach the buckles 601 from the clamping gaps 293 and detach the supporting legs 6, so as to reduce the volume of the pet toilet, thereby facilitating transporting and retracting the pet toilet.

In the present embodiment, the pet toilet further includes a casing 7, a control motherboard 71, and a power supply module 72. The control motherboard 71 is electrically connected to the power supply module 72. The casing 7 has a fifth accommodation space 73, the fifth accommodation space 73 is formed by side walls of the casing 7, and both the control motherboard 71 and the power supply module 72 are arranged in the casing 7. Among them, an interface group 74 is further included, and the interface group 74 includes a plurality of interfaces. The casing 7 is provided with a plurality of first mounting openings 75, and the interface group 74 is electrically connected to the control motherboard 71 and the power supply module 72. The interface group 74 is arranged in the first mounting openings 75, and a sealing element 76 is arranged between the interface group 74 and an inner wall of each first mounting opening 75. Specifically, an infrared detection device 77 is further included, the infrared detection device 77 is connected to the roller 1 or the base 2, and the infrared detection device 77 is configured to detect whether a pet has entered the roller 1. Furthermore, the pet toilet further includes a Hall sensing device 78, the Hall sensing device 78 has a position configured to detect rotation of the roller 1. Furthermore, the Hall sensing device 78 includes a magnet sensing area 781, a first magnet pole 782, and a second magnet pole 783. The magnet sensing area 781 is arranged on the first supporting arm 22 and/or the second supporting arm 23, and the first magnet pole 782 and the second magnet pole 783 are arranged on the roller 1. When the roller 1 rotates to the original position, the first magnet pole 782 is located in the magnet sensing area 781; and when the roller 1 rotates to the defecation position, the second magnet pole 783 is located in the magnet sensing area 781. Furthermore, the interface group 74 includes at least one infrared detection device interface 741, a Hall sensing device interface 742, and a power supply interface 743. The infrared detection device interface 741 is configured to be electrically connected to the infrared detection device 77, the Hall sensing device interface 742 is configured to be electrically connected to the Hall sensing device 78, and the power supply interface 743 is configured to supply power to the drive device 5. Through the above structure, by arranging the infrared detection device 77, it is possible to detect whether a pet has entered the roller 1. When it is detected that a pet enters the roller 1, defecates, and leaves from the roller 1, the control motherboard 71 can control the roller 1 to rotate from the original position towards the defecation position according to feedback signals of the infrared detection device 77. When the magnet sensing area 781 senses the second magnet pole 783, the roller 1 rotates to the defecation position, and the control motherboard 71 controls the roller 1 to stop rotating according to feedback signals of the Hall sensing device 78, such that excrement is discharged into the fecal collection box 3. After the excrement is discharged to the fecal collection box 3, the control motherboard 71 controls the roller 1 to rotate back from the defecation position towards the defecation device. When the magnet sensing area 781 senses the first magnet pole 782, the roller 1 rotates to the original position, the control motherboard 71 controls the roller 1 to stop rotating according to feedback signals of the Hall sensing device 78, such that the roller 1 is maintained at the original position for pets to enter, exit, and defecate. Furthermore, both the power supply module 72 and the control motherboard 71 are located in the casing 7, and the casing 7 is provided with the infrared detection device 77 and the power supply interface 743. In this way, modular design is implemented, and assembly among the power supply module 72, the control motherboard 71, the infrared detection device 77, the Hall sensing device 78, and the drive device 5 is facilitated. Moreover, since the sealing element 76 is arranged between the interface group 74 and the inner wall of each first mounting opening 75, liquid can be prevented from leaking into the casing 7, such that the power supply module 72 and the control motherboard 71 in the casing 7 are prevented from being corroded by liquid. Moreover, liquid is prevented from leaking into the casing 7 and causing short-circuit of the power supply module 72 and the control motherboard 71, so that service life of the pet toilet is further improved.

In the present embodiment, a middle part of the sieve component 12 recesses towards a direction facing the inner wall of the roller 1 to form a diversion channel 1211. Through the above structure, it is convenient for excrement to be discharged into the fecal collection box 3 along the diversion channel 1211 and through the first opening 11 and the second opening 31.

The sieve component 12 includes a first part 122 and a second part 123, the first part 122 is connected to the roller 1, the second part 123 is connected to the first part 122, and the second part 123 is located between the first accommodation space 111 and the first part 122. The second part 123 is provided with a plurality of sieve pores 1231. Specifically, a depth of the diversion channel 1211 gradually increases along a direction from the second part 123 to the first part 122, and a width of the diversion channel 1211 gradually decreases along the direction from the second part 123 to the first part 122. Furthermore, the first part 122 includes a first baffle 1221 and a second baffle 1222, one side of the first baffle 1221 is connected to the second part 123, and a middle part of another side of the first baffle 1221 is connected to a middle part of the roller 1. Two ends of another side of the first baffle 1221 are connected to two ends of the roller 1 through the second baffle 1222, and the second baffle 1222 and the first baffle 1221 are arranged to form an acute angle, a right angle, or an obtuse angle. Moreover, the second baffle 1222 can further play a role of blocking pet litter to prevent pet litter from splashing into external environment when the roller 1 rotates.

The above description only describes embodiments of the present disclosure, and is not intended to limit the present disclosure; various modifications and changes can be made to the present disclosure. Any modifications, equivalent substitutions, and improvements made within the spirit and scope of the present disclosure are intended to be included within the scope of the present disclosure.

1. A pet toilet comprising:
a roller, the roller comprising a first opening and a first accommodation space, the first opening being in communication with the first accommodation space, and the first accommodation space being configured for accommodating excrement of pets and pet litter;
a base, the base being configured for supporting the roller;
a fecal collection box, the fecal collection box being arranged under the base, the fecal collection box defining a second accommodation space and a second opening, and the second opening being in communication with the second accommodation space;
a sieve component, the sieve component being connected to the roller, and the sieve component and an inner wall of the roller being configured to surround to form a third accommodation space, the third accommodation space being adjacent to the first accommodation space, and the sieve component being configured for sifting the pet litter from the excrement;
a drive device, wherein the drive device is configured for driving the roller to rotate on the base; when the first opening rotates along with the roller from an original position towards a defecation position, the pet litter is capable of entering the third accommodation space through the sieve component, the excrement is confined outside the third accommodation space, and the drive device is configure to drive the first opening to rotate along with the roller to be aligned with the second opening, so that the excrement is capable of being discharged into the second accommodation space by its own gravity through the first opening and the second opening; when the first opening rotates along with the roller from the defecation position towards the original position, the pet litter in the third accommodation space is capable of passing through the sieve component and falling back into the first accommodation space by its own gravity;
the drive device comprises a drive assembly, the drive assembly comprises a drive motor, a driving gear, and a driven gear, the drive motor is provided with a drive shaft, the driving gear is sleeved on the drive shaft, the driven gear is arranged on the roller, and the driven gear is configured for meshing with the driving gear, so that the drive shaft is configured for rotating to drive the driving gear to rotate, the driving gear is configured for rotating to drive the driven gear to rotate, and the driven gear is configured for rotating to drive the roller to rotate on the base;
the base is provided with a supporting portion, the supporting portion is configured for supporting the roller, the supporting portion defines a supporting groove, and the driven gear is positioned in the supporting groove;
a mounting groove is defined under the supporting groove, the mounting groove is in communication with the supporting groove, the driving gear is arranged in the mounting groove, and at least one portion of the driving gear extends into the supporting groove.

2. The pet toilet according to claim 1, wherein the supporting groove is configured for supporting the roller.

3. The pet toilet according to claim 2, wherein a first side of the roller is provided with a supporting shaft, a side wall of the supporting groove is recessed to form an annual supporting groove, and the supporting shaft is supported within the annual supporting groove; a lower side of the supporting groove is in communication with the mounting groove.

4. The pet toilet according to claim 1, wherein the pet toilet further comprises a sealing door, the sealing door is arranged at the second opening, and the sealing door is slidably connected to the fecal collection box, so that the sealing door is capable of sliding on the fecal collection box; when the first opening rotates along with the roller from an original position towards a defecation position, the pet litter is capable of entering the third accommodation space through the sieve component, the excrement is confined outside the third accommodation space, the drive device is configured to drive the sealing door to open the second opening, and the first opening is configured to rotate along with the roller to be aligned with the second opening, so that the excrement is capable of being discharged into the second accommodation space by its own gravity through the first opening and the second opening; when the first opening rotates along with the roller from the defecation position towards the original position, the pet litter in the third accommodation space is capable of passing through the sieve component and falling back into the first accommodation space by its own gravity, and the drive device is configured to drive the sealing door to close the second opening.

5. The pet toilet according to claim 4, wherein the drive device further comprises a transmission assembly, when the first opening rotates along with the roller from the original position towards the defecation position, the roller is configured to drive the sealing door to open the second opening through the transmission assembly, and the first opening is configured to rotate along with the roller to be aligned with the second opening, so that the excrement is capable of being discharged by its own gravity into the second accommodation space through the first opening and the second opening; when the first opening rotates along with the roller from the defecation position towards the original position, the pet litter in the third accommodation space is capable of passing through the sieve component and falling back into the first accommodation space by its own gravity, and the roller is configured to drive the sealing door to close the second opening through the transmission assembly.

6. The pet toilet according to claim 5, wherein the transmission assembly comprises a first transmission element and a second transmission element, the first transmission element is arranged on an outer side wall of the roller, the second transmission element is arranged on the sealing door, when the first opening rotates along with the roller from the original position towards the defecation position, the first transmission element is connected in transmission with the second transmission element, the roller is configured for rotating to drive the first transmission element to rotate, the first transmission element is configured for rotating to drive the second transmission element to move, so that the sealing door moves along with the second transmission element to open the second opening, and the first opening is configured to rotate along with the roller to be aligned with the second opening, so that the excrement is capable of being discharged by its own gravity into the second accommodation space through the first opening and the second opening; when the first opening rotates along with the roller from the defecation position towards the original position, the first transmission element is connected in transmission with the second transmission element, the pet litter in the third accommodation space is capable of passing through the sieve component and falling back into the first accommodation space by its own gravity, and the first transmission element is configured for rotating to drive the second transmission element to move, so that the sealing door moves along with the second transmission element to close the second opening.

7. The pet toilet according to claim 6, wherein a sliding rail is arranged on the fecal collection box, the roller is configured for rotating to drive the first transmission element to rotate, and rotation of the first transmission element drives the second transmission element to move, so that the sealing door is configured to slide along with the second transmission element on the sliding rail until opening or closing the second opening.

8. The pet toilet according to claim 7, wherein the first transmission element is a first arc-shaped rack arranged along an outer circumferential wall of the roller, the sealing door is a flat-shaped sealing door, the second transmission element is a second flat-shaped rack arranged on the sealing door, the sliding rail is a flat-shaped sliding rail, and the roller is configured for rotating to drive the first rack to rotate, so that the first rack drives the second rack to move, and the sealing door is configured to slide along with the second rack on the sliding rail until opening or closing the second opening.

9. The pet toilet according to claim 7, wherein the first transmission element is a first arc-shaped rack arranged along an outer circumferential wall of the roller, the sealing door is an arc-shaped sealing door, the second transmission element is a second arc-shaped rack arranged on the sealing door, the sliding rail is an arc-shaped sliding rail, and the roller is configured for rotating to drive the first rack to rotate, so that the first rack drives the second rack to move, and the sealing door is configured to slide along with the second rack on the sliding rail until opening or closing the second opening.

10. The pet toilet according to claim 4, wherein a third opening is defined in the base, the third opening is positioned between the roller and the second opening, when the first opening rotates along with the roller from the original position towards the defecation position, the pet litter is capable of entering the third accommodation space through the sieve component, the excrement is confined outside the third accommodation space, the sealing door is configured to open the second opening, and the first opening is configured to rotate along with the roller to be aligned with the third opening and the second opening, so that the excrement is capable of being discharged by its own gravity into the second accommodation space through the first opening and the second opening; when the first opening rotates along with the roller from the defecation position towards the original position, the first opening is misaligned with the second opening and the third opening, the pet litter in the third accommodation space is capable of passing through the sieve component and falling back into the first accommodation space by its own gravity, and the sealing door is configured to close the second opening.

11. The pet toilet according to claim 10, wherein the supporting portion comprises a first supporting arm arranged on a first side of the base and comprises a second supporting arm arranged on a second side of the base, the first supporting arm and the second supporting arm are both provided with a supporting groove, both sides of the roller are provided with supporting shafts, and the supporting shafts are positioned in the supporting grooves; a plurality of first wheels are arranged in the supporting grooves, and the first wheels are configured for supporting the supporting shafts.

12. The pet toilet according to claim 11, wherein the base is further provided with a recessed portion recessed in a direction away from the roller; when the roller is supported on the base, a gap exists between the roller and an inner wall of the recessed portion, and the recessed portion is provided with a second wheel; the third opening is arranged at the recessed portion.

13. The pet toilet according to claim 1, wherein an inner wall of the mounting groove is provided with a fourth opening, and the mounting groove is in communication with the outside via the fourth opening.

14. The pet toilet according to claim 9, wherein the fecal collection box is further provided with a first avoidance groove, and the first avoidance groove is configured for accommodating the first rack and the second rack.

15. The pet toilet according to claim 1, wherein the fecal collection box is provided with a first outer side wall and a first bottom wall, the first bottom wall is connected to the first outer side wall, a distance between a first side of the first bottom wall and a bottom end of the first outer side wall is defined as a first distance, a distance between a second side of the first bottom wall and the bottom end of the first outer side wall is defined as a second distance, and the first distance is different from the second distance, so that the first bottom wall is arranged at an inclined angle.

16. The pet toilet according to claim 1, wherein the base is provided with a locking device, the locking device is configured for locking the fecal collection box detachably under the base.

17. The pet toilet according to claim 1, wherein a plurality of protruding frames are arranged in the first accommodation space.

18. The pet toilet according to claim 17, further comprising a cushion body, wherein the cushion body is configured for detachably covering the frames and a bottom surface of the first accommodation space.

19. The pet toilet according to claim 18, wherein the cushion body is engaged with an inner wall of the roller in a snap-fit manner; the cushion body is provided with a snap-fit portion, the inner wall of the roller is provided with a snap-fit engaging portion, and the snap-fit portion is detachably connected to the snap-fit engaging portion.

20. The pet toilet according to claim 1, wherein a circular leak-proof ring is arranged in the first accommodation space, and the circular leak-proof ring is configured for blocking the excrement of pets in the first accommodation space.
